(19) United States
(12) Patent Application Publication
(10) Pub. No.: US 2013/0157687 A1
(43) Pub. Date: Jun. 20, 2013

(54) WIRELESS NETWORK SYSTEM AND WIRELESS TERMINAL CONNECTING METHOD

(71) Applicant: Panasonic Corporation, Osaka (JP)

(72) Inventor: Keiji MORI, Osaka (JP)

(73) Assignee: Panasonic Corporation, Osaka (JP)

(21) Appl. No.: 13/706,504

(22) Filed: Dec. 6, 2012

(30) Foreign Application Priority Data
Dec. 20, 2011 (JP) 2011-278075
Oct. 16, 2012 (JP) 2012-228726

(51) Int. Cl. H04W 48/20

(52) U.S. Cl. CPC H04W 48/20
USPC 455/456.1

(57) ABSTRACT

A wireless network system includes wireless base stations, wireless terminals and a server. Each wireless terminal includes a terminal communications circuit configured to connect the terminal itself to each wireless base station, to get a first piece of information about a communication condition of ongoing communication between itself and each wireless base station, to connect the terminal itself to another wireless terminal, to get a second piece of information about a communication condition of ongoing communication between the two wireless terminals, and to send the first and second pieces of information to the server. The server includes: a server communications circuit configured to get the first and second pieces of information from the terminal communications circuit of each wireless terminal; and a processing circuit configured to locate the wireless terminals by reference to the first and second pieces of information and to output information about their locations.

### BACKGROUND

1. Technical Field

The present disclosure relates to a wireless network system including a plurality of wireless terminals and wireless base stations and also relates to a wireless terminal connecting method for determining which wireless base station each wireless terminal should be connected to.

2. Description of the Related Art

When a telecommunications system is established by connecting a plurality of terminals to the same network either indoors or in an airplane or any other kind of transportation, a method of connecting those terminals to a network cable installed has ordinarily been adopted.

As a typical example of such a telecommunications system, known is a so-called “in-flight entertainment system (IFE)” which has become increasingly popular these days in the field of air transportation industry. An IFE includes multiple pairs of monitors and controllers, each of which is installed in each seat of an airplane. A passenger can enjoy watching a movie or playing a game by using the monitor and controller in his or her seat. Those monitors of the IFE are connected to a wired network (which will be sometimes referred to herein as a “wired LAN (local area network)”) in the airplane. Content data such as the movie or the game is transmitted from a server which is installed in the airplane over a wired network and then displayed on those monitors.

Such a method of transmitting data over a wired network certainly ensures high reliability. However, it takes a lot of time and cost to install a network cable and it also takes much trouble to get maintenance done after the network cable has been installed.

In addition, in any kind of transportation (particularly in an airplane), only a limited internal space is available for installing the equipment. That is why it is also a problem exactly how to secure a space for installing the cable. On top of that, as the fuel cost of airplanes is skyrocketing in recent years, more and more plane body makers and airlines are strongly requesting plane equipment makers to contribute to lowering the fuel cost in one way or another. A cable compliant with an airplane standard is very expensive and very heavyweight. That is why it is a problem in terms of cost and fuel cutting to install such a heavyweight cable.

Meanwhile, a wireless network that uses no connecting cable to terminals (which will be referred to herein as a “wireless LAN”) has been proposed recently for use in such applications and has gradually been adopted one after another. Compared to the traditional wired network, the wireless network can save a lot of time and cost that it would otherwise take to install and maintain such a heavy cable.

Also, when such a wireless network is installed in some kind of transportation such as an airplane, it is very beneficial to cut down the space to be left for installing the cable or the weight of the cable itself by adopting such a wireless technique.

It should be noted that generally speaking, every passenger is prohibited from using any radio wave emitting device in an airplane. This rule is set in view of not only a radio wave interference problem, to which the airplane's equipment would otherwise be subjected, but also a difference in usable radio frequency from one country to another.

However, except when the airplane is taking off or landing, the in-airplane wireless LAN has only a little influence on the operation of the airplane. That is why in recent years, only while the airplane is flying with stability except when taking off or landing, a wireless LAN connection service is provided for passengers' PCs (personal computers) or PDAs (personal digital assistants) in increasing numbers of airlines.

Before such a wireless network for an airplane is described, the traditional in-airplane wired network will be described.

The traditional in-airplane wired network may be hardwired as shown in FIG. 1, which is a side view of an airplane and illustrates a general configuration for such an in-airplane network. In FIG. 1, the left-hand side corresponds to the frontend of the airplane. Also, in FIG. 1, passenger terminals 704a and 704b installed at respective seats (not shown) provide service content such as movies or games for passengers.

Data of those movies and games is stored in a server 702 which is installed near the frontend of the airplane body. The server 702 is connected to a first group of routers 701 over a wired network 703. The first group of routers 701 is ordinarily put behind the ceiling 705 of the airplane body. For example, routers 701a and 701b of the first group are arranged in this order from the head of the airplane body toward its tail and are connected together with a daisy chain.

Each of the routers 701a and 701b of the first group is also connected to another wired network 703, which is branched toward the floor of the airplane body, and relays the data over the wired network 703. This wired network 703 is connected to a router 707a of a second group, which is put under the floor 706 of the airplane body. Another router 707b of the second group is connected to the router 707a of the second group. These routers 707a and 707b of the second group are arranged in this order from the head of the airplane body toward its tail and are connected together with a daisy chain.

These routers 707a and 707b of the second group are also connected to the passenger terminals 704a and 704b, respectively. It should be noted that multiple passenger terminals could be connected to a single router of the second group.

In an in-airplane network with such a configuration, a distribution request of some content (such as a movie or a game) that a passenger has selected using the passenger terminal 704b passes through the router 707b of the second group first over the wired network 703. Next, the request goes through the router 707a of the second group on the way toward the router 701a before reaching the router 701a of the first group. After that, the request passes through the router 701a of the first group on the way toward the server 702 before finally reaching the server 702.

In response to the request from the passenger terminal 704b, the server 702 distributes the content requested, which goes through the same route in the opposite direction (i.e., passes through the router 701a of the first group and the routers 707 of the second group) and reaches the passenger terminal 704.

If this wired network is turned into a wireless one, systems such as the ones shown in FIGS. 2A and 2B may be used. FIGS. 2A and 2B are side views of an airplane and illustrate general configurations of an in-airplane network. In FIGS. 2A and 2B, the left-hand side corresponds to the front end of the airplane body, the profile of the airplane is not shown, and the reference numeral 805 denotes the ceiling and the reference numeral 806 denotes the floor.

In FIG. 2A, the passenger terminals 804a and 804b have a wireless client function, and can communicate with a first group of routers 801a and 801b that are arranged behind the ceiling 805 via wireless base stations 807a and 807b on the ceiling 805. The first group of routers 801a and 801b are connected to a server 802 over a wired network 803.

The content data stored in the server 802 is passed to the wireless base stations 807a and 807b over the wired network 803 and via the first group of routers 801a and 801b.

The wireless base stations 807a and 807b transform the data that has been received over the wired network into wireless frames and send out those frames over the wireless network. In response, the passenger terminals 804a and 804b receive those wireless frames, get content information such as a movie or a game, and provide it for the passengers.

The wireless network shown in FIG. 2B has been described on the supposition that the second group of routers 707a and 707b shown in FIG. 1 are removed. However, a second group of routers 808a and 808b may be used in the wireless network as shown in FIG. 2B.

In that case, the wireless client function for receiving the wireless communications from the wireless base stations 807a and 807b may be provided for the second group of routers 808a and 808b instead of the passenger terminals 804a and 804b.

Each of the routers 808a and 808b of the second group is connected to its associated passenger terminal 804a or 804b over a wired network. Thus, as in the example shown in FIG. 1, the wireless communications received at the second group of routers 808a and 808b are passed to the passenger terminals 804a and 804b over the wired networks 803a and 803b.

By adopting a wireless network with such a configuration, a network can be established in an airplane. However, it is difficult to constantly provide a network resource for a wireless network just by automatically connecting together the wireless base stations and the wireless terminals. Particularly when distributing video, it is especially difficult to maintain stabilized video quality. That is why the wireless terminals need to be connected to wireless base stations that can receive radio waves with even more stability.

A general solution in this technology may be determining in advance an appropriate combination of a wireless base station and a wireless terminal that should be connected together and registering such a combination with the wireless terminal beforehand. However, the wireless environment in an airplane is so much unstable that it is difficult to establish a stabilized wireless network based on that data that has been collected only once beforehand. On top of that, since the equipment is supposed to be installed in an airplane by an installation expert, it is difficult to carry out complicated settings unless the person is familiar with such a wireless network.

To overcome such a problem in the related art, a telecommunications system such as the one shown in FIG. 3 has been proposed. The telecommunications system shown in FIG. 3 includes wireless base stations 901a and 901b, a server 902, and wireless terminals 904a through 904d. The wireless base stations 901a, 901b and the server 902 are connected together with a wired network 903.

After having been started, the wireless terminals 904a through 904d request and receive beacon frames and probes compliant with the IEEE 802.11 standard, thereby recognizing the presence of the wireless base stations 901a and 901b.

At the same time, the wireless terminals 904a through 904d measure the radio wave intensities of the wireless base stations 901a and 901b to extract only wireless base stations, of which the radio wave intensities are equal to or greater than a certain appropriate value, and then store the BSSIDs (basic service set identifiers), channels and radio wave intensities of the respective wireless base stations 901a and 901b as wireless base station information. The wireless terminals 904a through 904d choose one of the wireless base stations, from which the maximum radio wave intensity has been detected, by reference to the wireless base station information stored, and defines it as the wireless base station to be connected to.

In this manner, the wireless terminals 904a through 904d, along with the wireless base stations 901a and 901b that have been set, can establish infrastructure connection.

Japanese Laid-Open Patent Publication No. 2007-67745 (which will be referred to herein as “Patent Document No. 1” for convenience sake) discloses a technique by which a management device determines, by reference to information about radio waves provided by a wireless terminal, which wireless base station the wireless terminal should be connected to.

According to Patent Document No. 1, the management device is notified of the radio wave information of every wireless base station that has been recognized by a wireless terminal via the same wireless terminal. In response to that radio wave information, the management device chooses one of the wireless base stations so that the loads of the respective wireless base stations are distributed, notifies the wireless terminal of that, and the wireless terminal connects itself to the wireless base station specified.

### SUMMARY

The prior art technique needs further improvement in view of a communication band between wireless base stations and wireless terminals.

One non-limiting, and exemplary embodiment provides a technique to a technique for allowing each of multiple wireless terminals to secure a certain communication band in a situation where a wireless network is established by a plurality of wireless base stations and those wireless terminals.

In one general aspect, a wireless network system according to the present disclosure includes wireless base stations, wireless terminals and a server, all of which are arranged in a predetermined space. Each of the wireless terminals includes a terminal communications circuit which connects the wireless terminal to each of the wireless base stations, gets a first piece of information about a communication condition of ongoing communication between the wireless terminal itself and each of the wireless base stations, connects the wireless terminal to another one of the wireless terminals, gets a second piece of information about a communication condition of ongoing communication between the two wireless terminals, and sends the first and second pieces of information to the server. The server includes: a server communications circuit configured to get the first and second pieces of information from the terminal communications circuit of each said wireless terminal; and a processing circuit configured to locate the wireless terminals in the predetermined space by reference to the first and second pieces of information and configured to output information about their locations.

According to the above aspect, when a network is established between a plurality of wireless base stations and a plurality of wireless terminals, each of those wireless terminals can secure a certain communication band.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is a side view of an airplane and illustrates a general configuration for an in-airplane network.

FIGS. 2A and 2B are side views of an airplane and illustrate general configurations of an in-airplane network.

FIG. 3 illustrates a configuration for communications system.

FIG. 4 illustrates a situation where a wireless terminal 904a is connected to a wireless base station 901a and wireless terminals 904b, 904c and 904d are connected to a wireless base station 901b in the configuration shown in FIG. 3.

FIG. 5 illustrates a configuration for a wireless network system 100 as an embodiment of the present disclosure.

FIG. 6 illustrates a configuration for the wireless base station 101.

FIG. 7 illustrates a configuration for the server 102.

FIG. 8 illustrates a configuration for the wireless terminal 104.

FIGS. 9A to 9C show information about the received signal intensities (RSSI), respectively.

FIG. 10 is a flowchart showing the procedure of the operation of the system.

FIG. 11 illustrates the configuration of a wireless network system 100 with a larger number of wireless terminals than the system shown in FIG. 5.

FIG. 12 illustrates the relative locations of the wireless base stations 101a and 101b and the respective wireless terminals 104a through 104f.

FIG. 13 shows a wireless network system with the group-by-group averages specified when attention is paid to the wireless terminal 104f.

FIG. 14 shows a wireless network system with the group-by-group averages specified when attention is paid to the wireless terminal 104c.

FIG. 15 illustrates a configuration for a wireless network system 200 as a second embodiment of the present disclosure.

FIG. 16 illustrates the internal structure of the wireless base station 101b of the second embodiment.

FIG. 17A illustrates a range 300a in which the wireless terminal 104 can obtain a reception sensitivity that is equal to or higher than a predetermined level when Antenna A is used.

FIG. 17B illustrates a range 300b in which the wireless terminal 104 can obtain a reception sensitivity that is equal to or higher than a predetermined level when Antenna B is used.

FIG. 18 illustrates a configuration for a wireless network system, in which the transmission power of some wireless base station 101b may be increased or decreased.

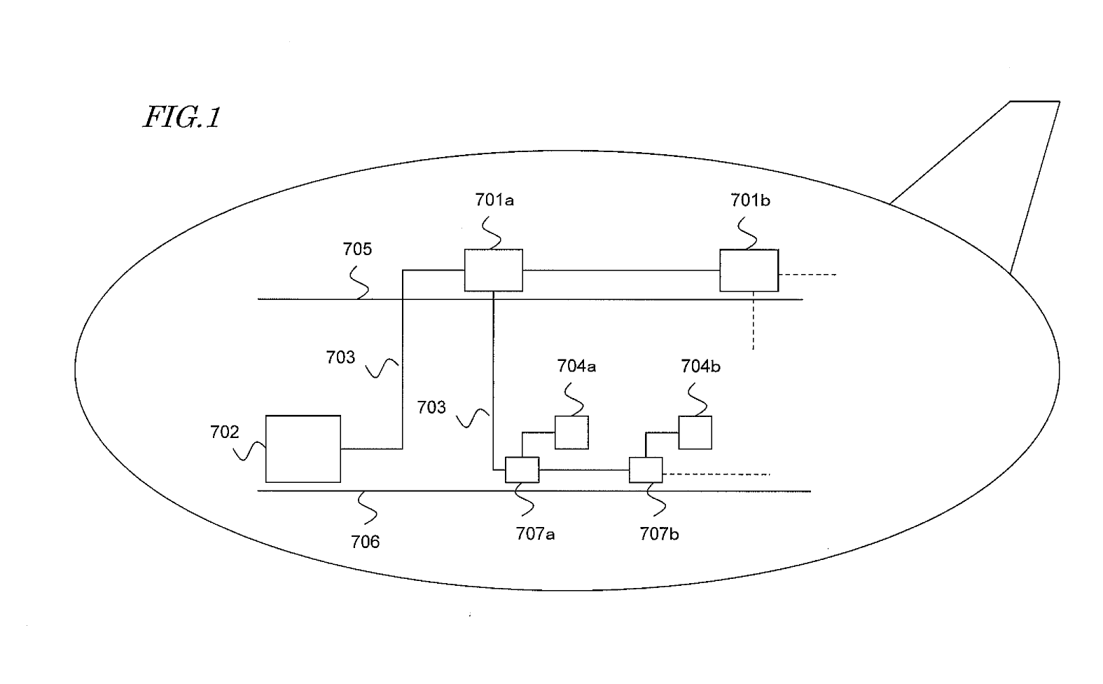

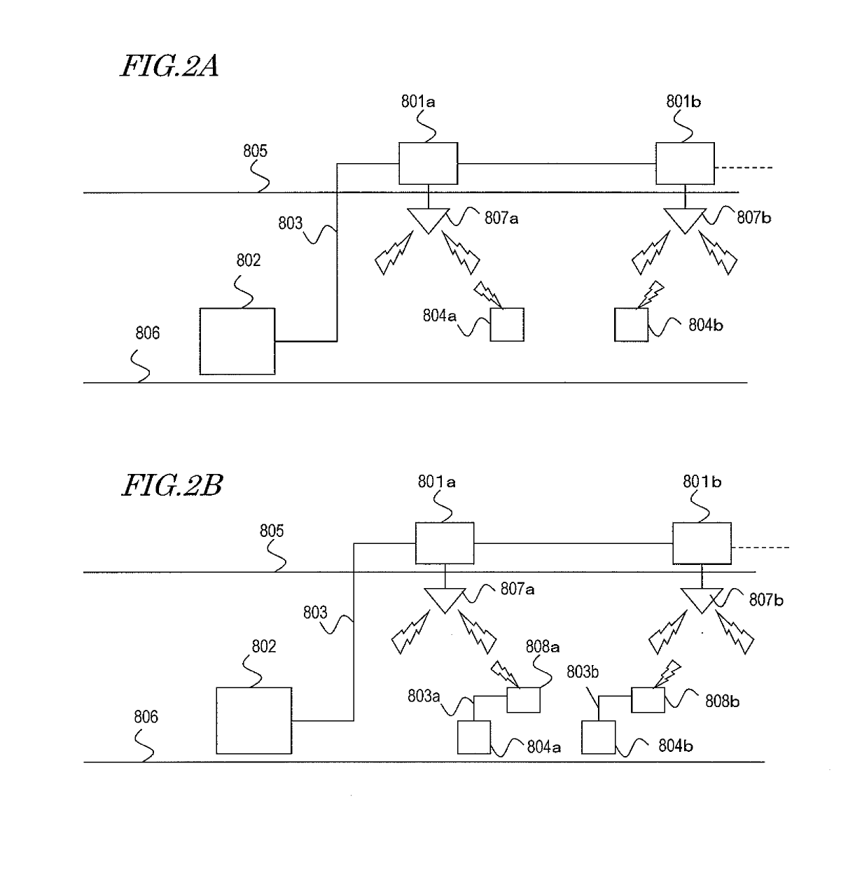

### DETAILED DESCRIPTION

According to the standard technology such as the one disclosed in Japanese Laid-Open Patent Publication No. 2007-67745, a wireless terminal gets connected to a wireless base station so that the load is distributed among a plurality of wireless base stations in accordance with the radio wave information of the wireless base stations that have been identified by the wireless terminals.

However, the present inventor considers that with such a standard technology adopted, sometimes it could be difficult to secure an appropriate radio frequency band for each of those wireless terminals. The reason is that since the wireless environment in an airplane could change dramatically according to the situation, the radio wave intensity measured could have significant errors in some cases. And if a wireless terminal gets connected to a wireless base station by reference to such inaccurate wireless base station radio wave information, the radio frequency band required cannot always be secured. In this description, the expression “the wireless environment in an airplane could change dramatically according to the situation” refers to a disturbance in radio wave due to the move of a cabin attendant or a passenger in an airplane, for example.

In such a wireless environment, the radio wave intensity of a wireless base station which is located distant from a certain wireless terminal could temporarily increase in some situation. If that wireless terminal gets connected to that distant wireless base station in such a situation, the radio wave intensity would decrease and the link would lose its stability sooner or later. In that case, it can be said that such a combination of the wireless base station and the wireless terminal is an inappropriate one.

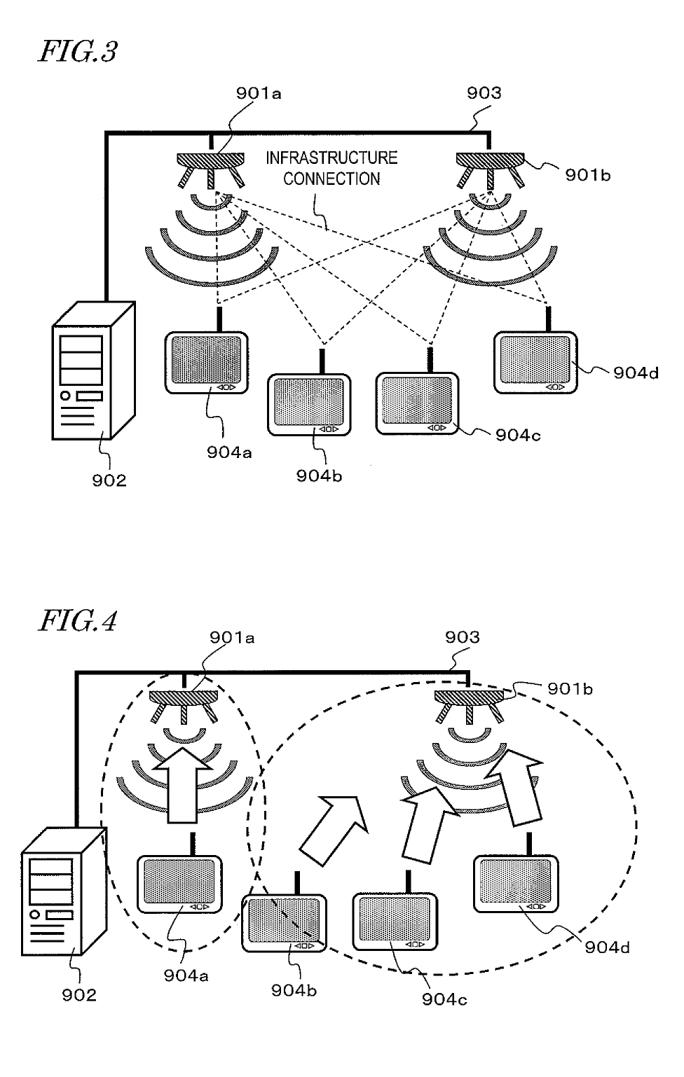

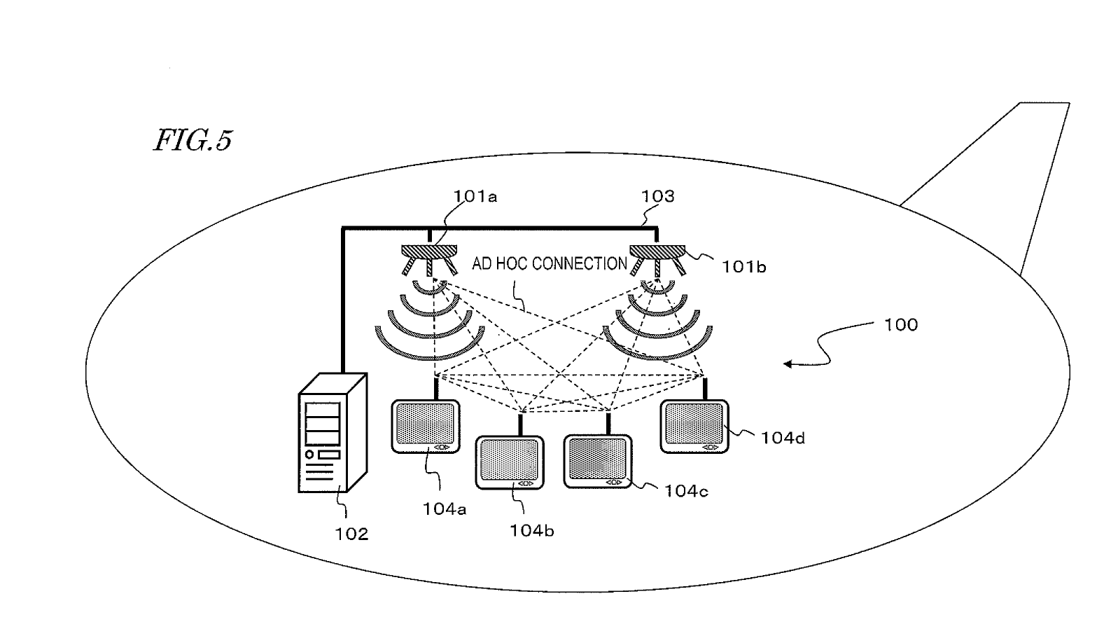

Meanwhile, even if the radio wave intensity measured is hardly erroneous and if respective wireless terminals get connected to the best wireless base stations, the load could still be overconcentrated at some wireless base stations when the system is viewed as a whole. For example, FIG. 4 illustrates a situation where a wireless terminal 904a is connected to a wireless base station 901a and wireless terminals 904b, 904c and 904d are connected to a wireless base station 901b in the configuration shown in FIG. 3. In that case, the wireless base station 901b at which the load is overconcentrated cannot secure any appropriate communication band.

As can be seen, according to the standard technology, it is difficult to optimize the connections of wireless base stations and wireless terminals over the entire system with a communication band secured for each of those connections. In that case, wireless distribution of video or games, which should always be secured a radio frequency band required, cannot get done with stability.

Hereinafter, embodiments will be described with reference to the accompanying drawings as needed. It should be noted that the description thereof will be sometimes omitted unless it is absolutely necessary to go into details. For example, description of a matter that is already well known in the related art will be sometimes omitted, so will be a redundant description of substantially the same configuration. This is done solely for the purpose of avoiding redundancies and making the following description of embodiments as easily understandable for those skilled in the art as possible.

It should be noted that the present inventor provides the accompanying drawings and the following description to help those skilled in the art understand the present disclosure fully. And it is not intended that the subject matter defined by the appended claims is limited by those drawings or the description.

### Embodiment 1

[1-1. Configuration]

FIG. 5 illustrates a configuration for a wireless network system 100 as an embodiment of the present disclosure. In this embodiment, the wireless network system 100 is supposed to be a so-called “in-flight entertainment system (IFE)” to be installed in an airplane.

The wireless network system 100 includes wireless base stations 101a and 101b, a server 102, a wired network 103 and wireless terminals 104a through 104d.

Hereinafter, the configurations of the wireless base stations 101a and 101b, the server 102 and the wireless terminals 104a through 104d will be described. In this description, the wireless base stations 101a and 101b will be collectively referred to herein as the “wireless base station 101” and the wireless terminals 104a through 104d will be collectively referred to herein as the “wireless terminal 104”.

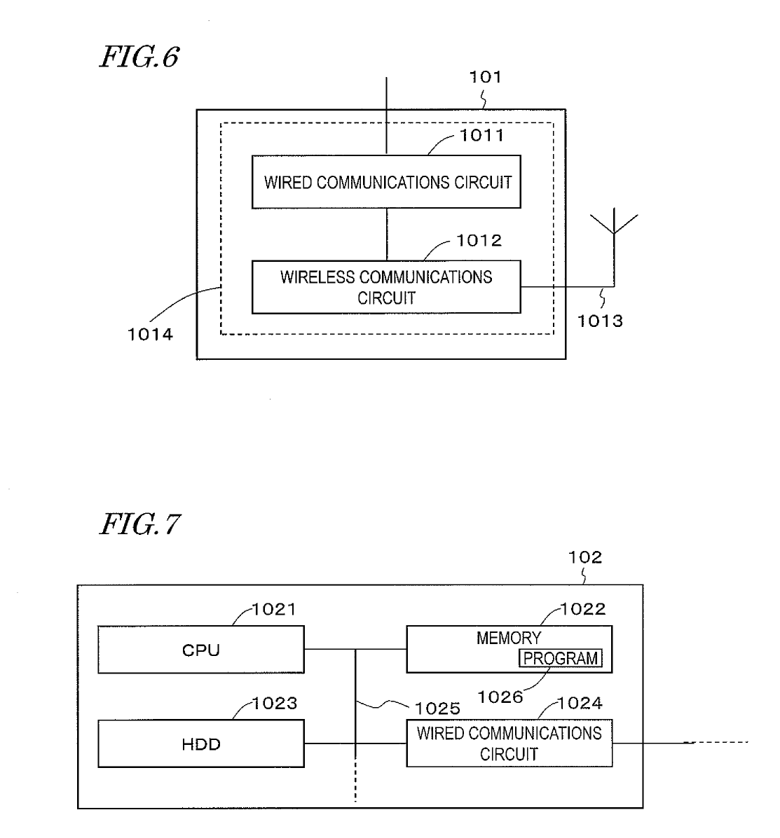

FIG. 6 illustrates a configuration for the wireless base station 101, which includes a wired communications circuit 1011, a wireless communications circuit 1012 and an antenna 1013.

The wired communications circuit 1011 is a network controller compliant with the Ethernet™ standard, for example, and is connected to the wired network 103 so as to send and receive data over the wired network 103. The wired communications circuit 1011 transmits the data obtained to the wireless communications circuit 1012, and receives the data that has been obtained by the wireless communications circuit 1012. The wireless communications circuit 1012 is a communications circuit which performs wireless communications compliant with the wifi™ standard, for example. The wireless communications circuit 1012 supplies predetermined reception power and transmission power to the antenna 1013 and sends and receives data via wireless communications.

These wired and wireless communication standards that are adopted as an example in this embodiment will also be adopted in the other embodiments of the present disclosure and the description thereof will be omitted herein.

In this description, the wired and wireless communications circuits 1011 and 1012 will sometimes be collectively referred to herein as “communication processing circuit 1014”, which may be a single-chip integrated circuit, for example.

The wireless base stations 101a and 101b are often installed on the ceiling of the cabin of an airplane. However, this is not a requirement of the present disclosure but there is no problem at all even if the wireless base stations 101a and 101b are put anywhere else (e.g., on the sidewalls) in an airplane.

FIG. 7 illustrates a configuration for the server 102, which includes a CPU 1021, a memory 1022, a hard disk drive (HDD) 1023, a wired communications circuit 1024 and a bus 1025.

The CPU 1021 is a signal processor which controls the overall operation of the server 102. As will be described later, the CPU 1021 performs processing that determines which wireless terminal should be connected to which wireless base station in this wireless network system 100. And that processing can be carried out by making the CPU 1021 execute a computer program 1026 which is stored in the memory 1022.

The HDD 1023 is a storage device which stores content data such as a movie or a game.

The wired communications circuit 1024 sends and receives data over the wired network 103, and is connected to the wireless base stations 101 through the wired network 103.

These components of the server 102 are connected together with the bus 1025 so as to communicate with each other.

Examples of the servers include a server with the function of distributing video and music, a server with the function of managing and controlling the equipment in the airplane. The server of this embodiment may be any of those various kinds of servers as long as it has the ability to collect data over a network. The server 102 is usually arranged near the head of an airplane. According to this embodiment, however, the server 102 may be arranged in any other location as long as the server 102 can get connected to the network. Or if a network system which can communicate with a device outside of the airplane is provided, then the server 102 may even be arranged outside of the airplane. Although the server 102 is supposed to communicate with the wireless base stations 101 in this embodiment, the server 102 may also communicate directly with the wireless terminals 104.

The wireless terminals 104a through 104d are telecommunications terminals to be installed on the back of the seats (not shown) in an airplane. However, some wireless terminal 104 may not be arranged on the back of a seat but may be housed inside of one of the armrests of a seat depending on the type of the seat. Alternatively, the wireless terminals 104a through 104d may even be mobile electronic devices such as PCs or PDAs that are carried on by passengers with themselves.

These wireless terminals 104a through 104d play back video, music or any other program that has been supplied from the server 102 and provide it for passengers. For that purpose, each of these wireless terminals 104a through 104d includes a processor, a monitor, a music playback function, and a user interface which are needed to play back the video, music or any other program. The user interface may be a physical button, a touchscreen panel on the monitor screen, or a separate controller.

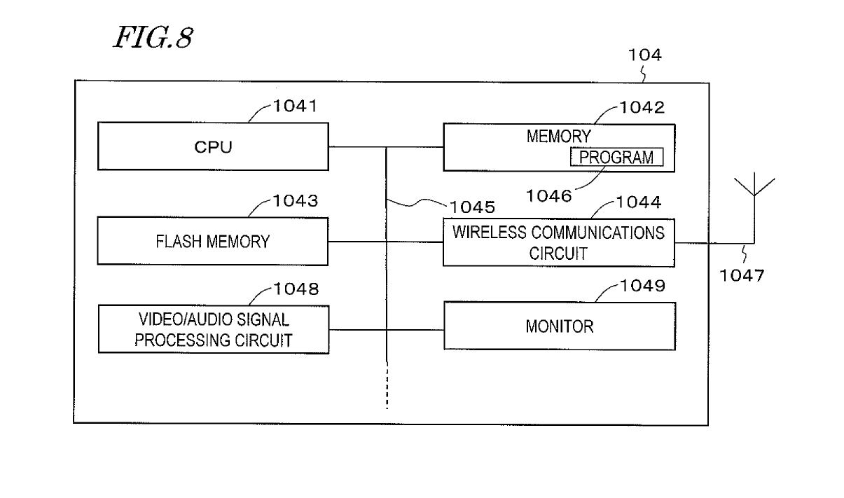

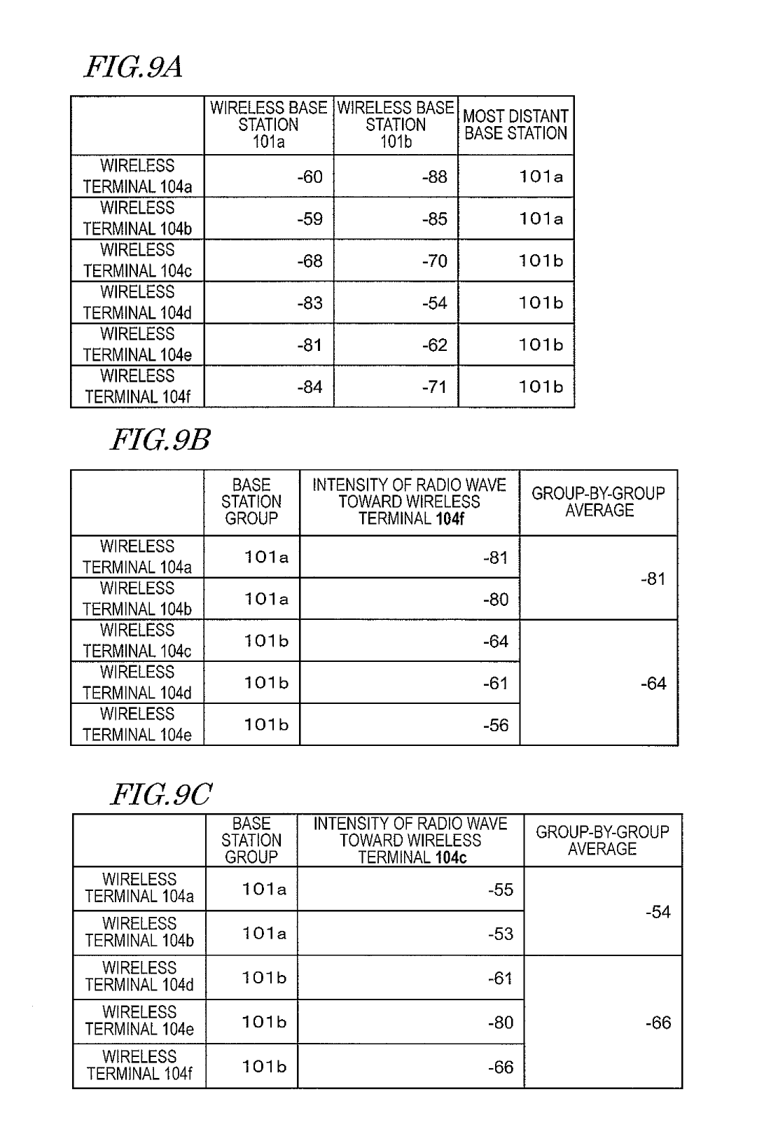

FIG. 8 illustrates a configuration for the wireless terminal 104, which includes a CPU 1041, a memory 1042, a flash memory 1043, a wireless communications circuit 1044, a video/music signal processing circuit 1048, a monitor 1046, an antenna 1047 and a bus 1045.

The CPU 1041 is a signal processor which controls the overall operation of this wireless terminal 104. The CPU 1041 gets connected to its associated wireless base station and generates information about the status of the communication between itself and the associated wireless base station (e.g., information about the intensity of a received signal). In addition, the CPU 1041 also gets connected to another wireless terminal 104 and generates information about the status of the communication between itself and that another wireless terminal (e.g., information about the intensity of a received signal). The CPU 1041 operates at the request of the server 102. For example, on receiving a request to send information from the server 102, the CPU 1041 controls its components so as to send that information to the server 102.

Such processing can be carried out by making the CPU 1041 execute a computer program 1049 which is stored in the memory 1042.

The flash memory 1043 is a storage device which stores the video or audio data gotten. Optionally, the flash memory 1043 may be replaced with an HDD.

In addition, the wireless terminals 104a through 104d also have a wireless LAN communication function. The wireless communications circuit 1044 performs wireless LAN communication processing via the antenna 1047. For that purpose, the wireless communications circuit 1044 supplies predetermined reception power and transmission power to the antenna 1047 and sends and receives data by making wireless communications.

By using its own wireless LAN communication function, each of the wireless terminals 104a through 104d can detect a beacon that has been transmitted by either the wireless base station 101a or 101b or another wireless terminal 104.

Moreover, by sending a probe request by itself, each of these wireless terminals 104a through 104d can also receive a probe response from either the wireless base station 101a or 101b or another wireless terminal 104. At that time, each of the wireless terminals 104a through 104d can obtain the received signal intensity (RSSI) of the wireless base station 101a or 101b or that another wireless terminal 104.

The video/audio signal processing circuit 1048 is a circuit for processing a signal representing the video to be displayed on the monitor 1046 or a signal representing the audio to be output through loudspeakers (not shown). Optionally, the video/audio signal processing circuit 1048 may be split into a dedicated video signal processor and a dedicated audio signal processor.

In the following description, the wireless base stations 101a and 101b and the wireless terminals 104a through 104d will sometimes be collectively referred to herein as “wireless devices”.

[1-2. Operation]

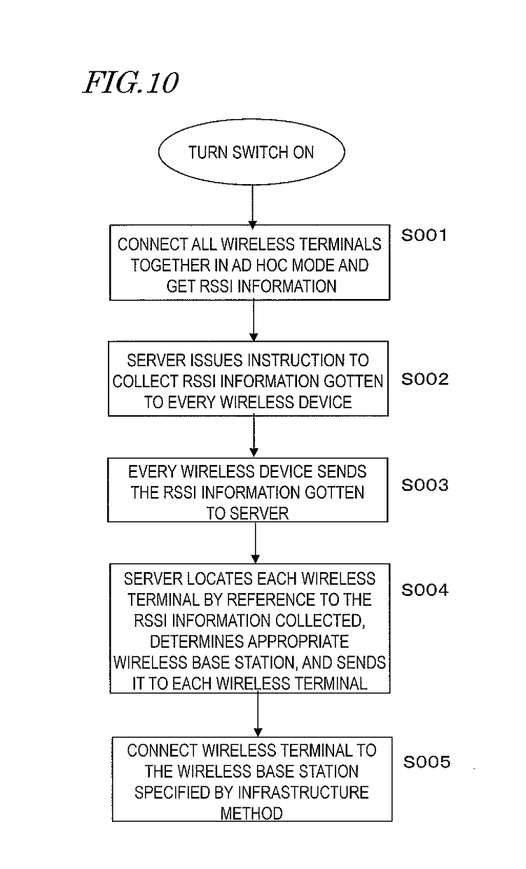

Hereinafter, it will be described with reference to FIGS. 9A to 9C, and 10 how the wireless network system 100 of this embodiment operates. FIGS. 9A to 9C show information about the received signal intensities (RSSI). FIG. 10 is a flowchart showing the procedure of the operation of the system. It should be noted that the wireless network system 100 shown in FIG. 5 is simplified for the purpose of describing its installation environment.

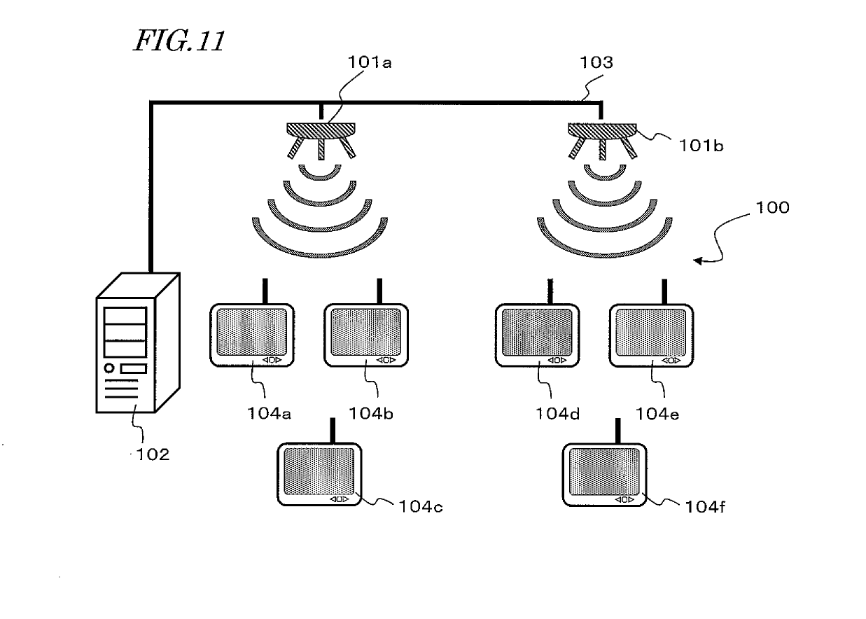

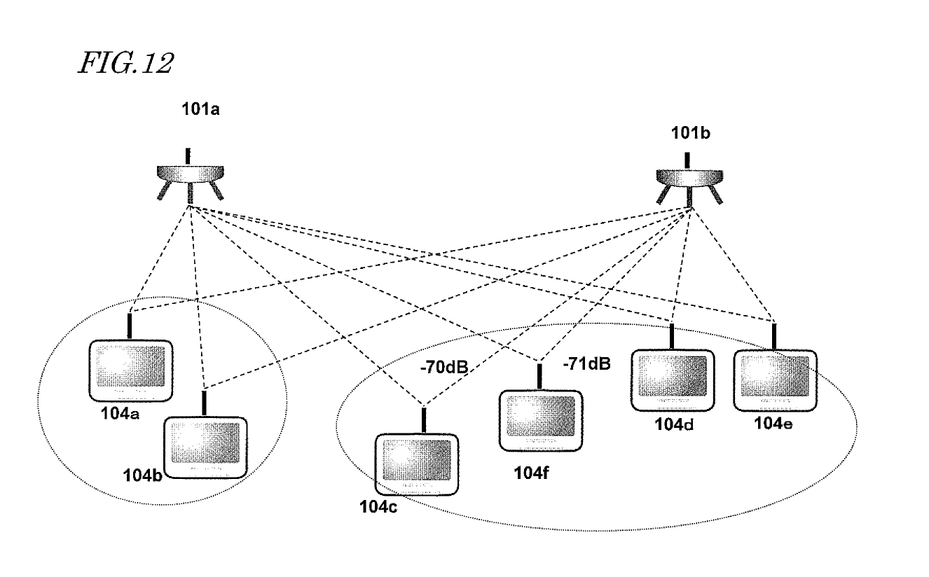

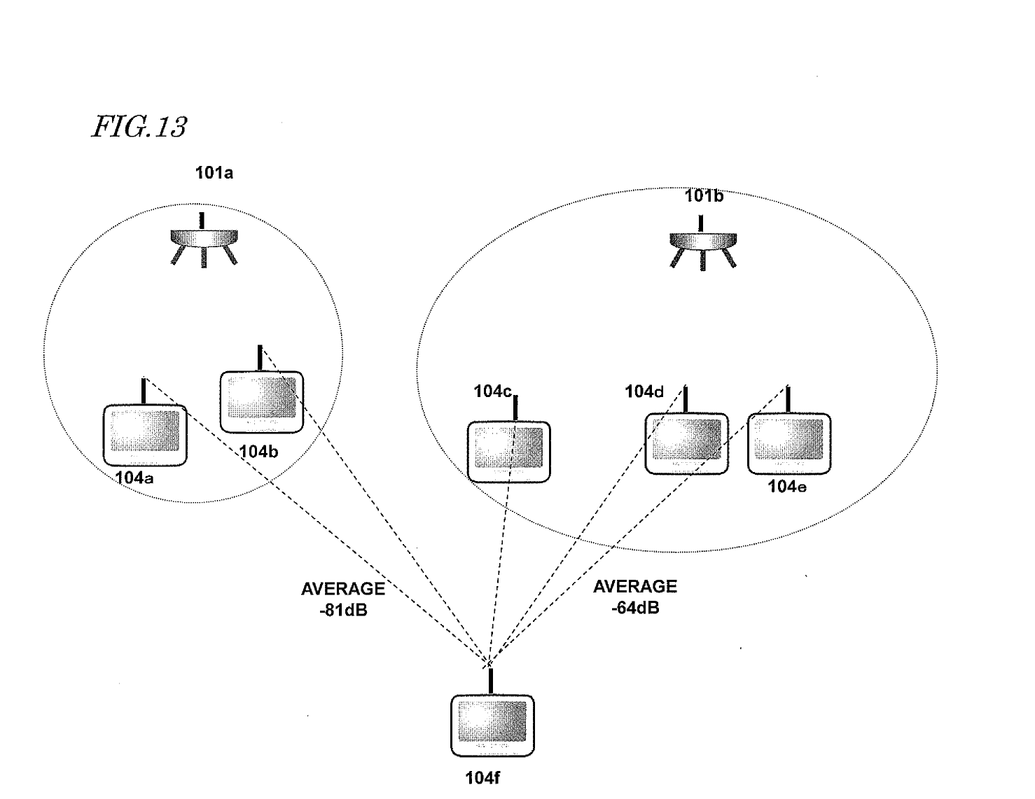

In the following example, the wireless network system 100 is supposed to include six wireless terminals 104a through 104f as shown in FIG. 11. In other words, FIG. 11 illustrates the configuration of a wireless network system 100 with a larger number of wireless terminals than the system shown in FIG. 5. It can be seen that two more wireless terminals 104e and 104f have been added to the system shown in FIG. 5.

After the respective devices that form this wireless network system have been turned ON and a program such as an OS (operating system) has been loaded, every wireless terminal sets its built-in wireless module in an ad hoc mode. In this case, the SSID (service set identifier) of the wireless network is set to be a particular one that has been defined in advance for every wireless device.

As a result, every wireless device gets connected to the same ad hoc network. The CPU 1041 of each wireless device sends a beacon frame, and sends and receives a probe request and response, thereby getting the RSSI of another wireless device which is located well within a radio wave's reach from itself (in Step S001).

When the CPU 1041 of every wireless device gets an RSSI, the CPU 1021 of the server 102 issues an instruction to collect the RSSI information gotten to every wireless device. This instruction is broadcast to those devices over the wired network 103 (in Step S002).

The instruction transmitted is delivered first to the wireless base stations 101a and 101b, which relay the instruction to the wireless LAN area. As a result, the instruction is delivered to every wireless terminal 104a through 104d.

On receiving the instruction to collect the RSSI information, the wireless communications circuit 1044 of each wireless device gets the RSSI information of every wireless device, which has been measured by its own CPU 1041, from the CPU 1041 and sends that information to the server 102. The RSSI information that has been sent from the wireless terminals 104a through 104d is received at the wireless base stations 101a and 101b and then delivered to the server 102 (in Step S003).

In this manner, those pieces of RSSI information of the respective wireless devices that have been measured in the ad hoc mode are collected in the server 102, which locates the wireless terminals 104a through 104d based on those pieces of information. Hereinafter, a specific example of such an operation will be described.

FIGS. 9A to 9C show an example of the RSSI information that has been measured by the wireless network system shown in FIG. 11, respectively. Specifically, FIG. 9A shows RSSI values that have been measured between the respective wireless terminals and the respective wireless base stations. FIG. 9B shows the RSSI values that have been measured between the wireless terminal 104f and the other wireless terminals. And FIG. 9C shows the RSSI values that have been measured between the wireless terminal 104c and the other wireless terminals. In FIG. 9A to 9C, the unit of the numerals is dBm.

In this case, the wireless terminals 104a through 104f can be located in the following manner.

Now take a look at FIG. 12 as well as FIGS. 9A to 9C. FIG. 12 illustrates the relative locations of the wireless base stations 101a and 101b and the respective wireless terminals 104a through 104f.

First of all, the CPU 1021 of the server 102 determines, based on the RSSI values between the wireless base stations 101a and 101b and the respective wireless terminals, which wireless base station each wireless terminal is located closer to.

As shown in FIG. 9A, the wireless terminals 104a and 104b see the wireless base station 101a have the higher radio wave intensity, while the wireless terminals 104c through 104f see the other wireless base station 101b have the higher radio wave intensity. Thus, the CPU 1021 of the server 102 associates the wireless terminals 104a and 104b with the wireless base station 101a and associates the wireless terminals 104c through 104f with the wireless base station 101b. By adopting such associations, combinations of the wireless base station and wireless terminals are determined. It can be said that the stronger the radio wave, the better the communication condition. That is why those wireless terminals are associated as candidates to be connected to the respective wireless base stations.

Next, the number of wireless terminals to be connected to each wireless base station is adjusted with the RSSI values between the respective wireless terminals also taken into account so as to fall within a particular range. In this description, “to make adjustment so that the number falls within a particular range” means making adjustment so that the number of wireless terminals connected becomes equal to either the largest integer that is equal to or smaller than x or the smallest integer that is equal to or greater than x supposing x is the value obtained by dividing the number of all wireless terminals by the number of all wireless base stations.

In the example shown in FIGS. 9A to 9C and 11, there are two wireless base stations and six wireless terminals. Thus, the CPU 1021 of the server 102 makes adjustment based on the RSSI information collected so that the wireless terminals are connected evenly to those wireless base stations (i.e., so that the number of wireless terminals connected to each wireless base station changes into three).

To change the number of wireless terminals connected to each wireless base station into three, adjustment needs to be made so that one of the four wireless terminals 104c through 104f that are connected to the wireless base station 101b is shifted to the other base station. The following is an example of computation to make such adjustment.

First of all, by reference to the RSSI information shown in FIG. 9A, the CPU 1021 of the server 102 looks for a candidate wireless terminal to be shifted to the other wireless base station among the four wireless terminals 104c through 104f which are currently paired with the wireless base station 101b. For that purpose, the RSSI values between the respective wireless terminals and the wireless base station 101b are compared to each other to find a wireless terminal that has the smallest RSSI value (i.e., is in the worst communication condition).

As shown in FIG. 9A, the wireless terminals 104f and 1040 have the smallest RSSI value of −71 dBm and the second smallest RSSI value of −70 dBm, respectively, and are picked as candidates, and the wireless terminal 104f in the worst communication condition is selected provisionally.

Next, the CPU 1021 of the server 102 determines, by reference to the RSSI information shown in FIG. 9B, whether or not the wireless terminal 104f is actually close to the wireless terminals 104a and 104b. That is to say, the CPU 1021 pays attention to the RSSI values between the wireless terminal 104f and the other wireless terminals. And those RSSI values are shown in FIG. 9B. Subsequently, the RSSI values shown in FIG. 9B are classified into the group to be connected to the wireless base station 101a and the group to be connected to the wireless base station 101b and their respective averages are calculated. In FIG. 9B, those averages are shown for the two groups. And FIG. 13 shows a wireless network system with the group-by-group averages specified when attention is paid to the wireless terminal 104f.

As can be seen from FIG. 9B, the average RSSI value between the wireless terminal 104f and the group of wireless terminals 104a and 104b to be connected to the wireless base station 101a is −81 dBm and the average RSSI value between the wireless terminal 104f and the group of wireless terminals 104c, 104d and 104e to be connected to the wireless base station 101b is −64 dBm. Thus, the average RSSI value between the wireless terminal 104f and the group of wireless terminals to be connected to the wireless base station 101b is the greater than the other average RSSI value. That is why the wireless terminal 104f should be located closer to the group of wireless terminals to be connected to the wireless base station 101b. In other words, the wireless terminal 104f should be located closer to those terminals 104c through 104e. Consequently, it is not appropriate to associate the terminal 104f with the group of terminals to be connected to the wireless base station 101b.

For that reason, the focus is shifted to the other candidate 104c.

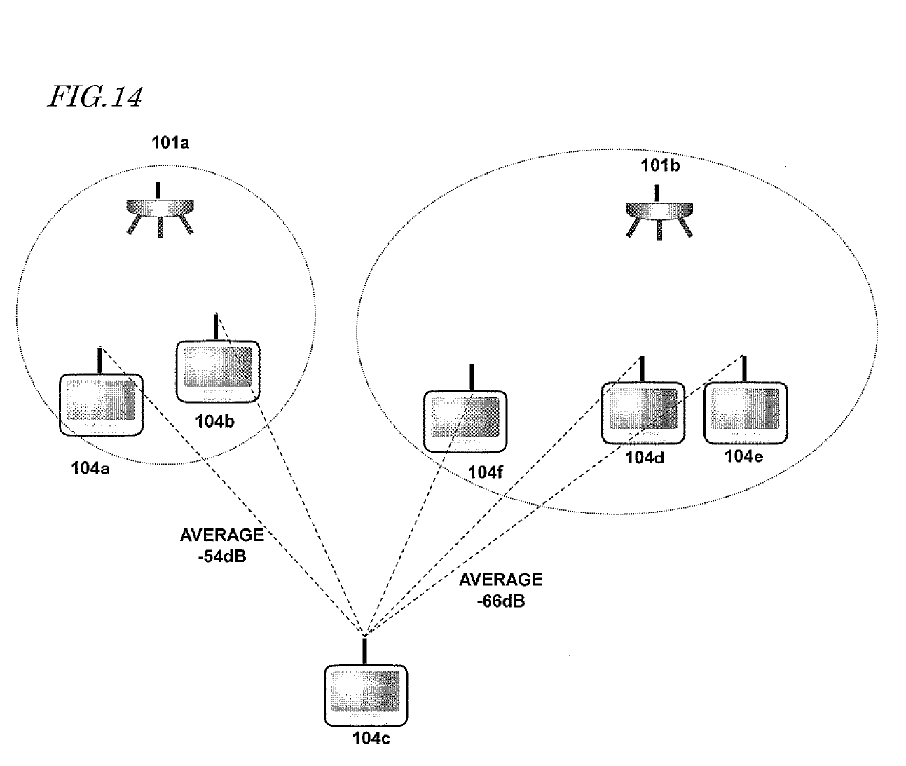

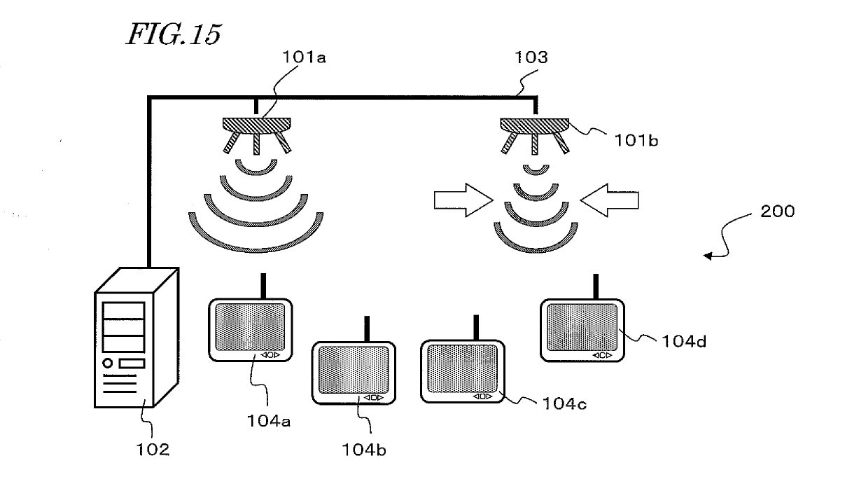

The CPU 1021 of the server 102 performs the same processing on the wireless terminal 104c as on the wireless terminal 104f. The average RSSI values for the two groups are shown in FIG. 9C. FIG. 14 shows a wireless network system with the group-by-group averages specified when attention is paid to the wireless terminal 104c.

As can be seen from FIG. 9C, as for the wireless terminal 104c, the average RSSI value for the group of wireless terminals 104a and 104b to be connected to the wireless base station 101a is greater than the other. That is to say, it can be said that the wireless terminal 104c is located closer to the wireless terminals 104a and 104b. Consequently, it is appropriate to associate the terminal 104c with the group of terminals to be connected to the wireless base station 101a. As a result, association is made so that the wireless base station 101a is connected to the wireless terminal 104c.

As can be seen, by using not just RSSI values between wireless base stations and wireless terminals but also RSSI values between the wireless terminals themselves, their locations can be determined more accurately. In this case, the “locations” are the physical locations of a plurality of wireless terminals. If such physical locations of a plurality of wireless terminals are determined, then IP addresses can be allocated sequentially to the seats from the head of an airplane toward its tail. Also, if each wireless terminal is provided with a cabin attendant call function, then a cabin attendant called can quickly locate the wireless terminal calling (i.e., the seat of the passenger in question) and provide a requested service for him or her.

It should be noted that by additionally using the RSSI values between those wireless terminals, not just their physical locations but also the relative locations between those wireless terminals can be determined as well.

In this manner, the CPU 1021 of the server 102 determines the wireless base stations to which the respective wireless terminals 104a through 104f should be connected, and that information is sent to the respective wireless terminals (in Step 5004 shown in FIG. 10).

On receiving this information, the respective wireless terminals once cut off their current connection and then each get connected to the specified one of the wireless base stations 101a and 101b by the infrastructure method (in Step S005 shown in FIG. 10).

In the embodiment described above, the server 102 that distributes video and audio is supposed to function as an analyzer that determines the locations of the wireless base stations and wireless terminals. However, if the same calculations and communications as what has already been described can be carried out, there is no need to provide the server 102 independently. Instead, the server's (102) configuration may be built in any other wireless device such as one of the wireless base stations or one of the wireless terminals. That is to say, either the server and a wireless base station or the server and a wireless terminal may be housed in the same housing.

Also, in the embodiment described above, positioning is made provisionally according to the RSSI values between the wireless base stations and the wireless terminals and then done definitively with the RSSI values between the wireless terminals taken into account. However, this is just an example of the method of calculation. And this procedure is not necessarily adopted.

[1-3. Advantageous Effects, Inc.]

As described above, a wireless network system 100 as an embodiment of the present disclosure includes wireless base stations 101a and 101b, wireless terminals 104a through 104d and a server 102, all of which are arranged in a predetermined space. Each of those wireless terminals 104a through 104d includes a terminal communications circuit 1044 which connects the wireless terminal to each of the wireless base stations 101a and 101b, gets a first piece of information (received signal intensity (RSSI) information) about a communication condition of ongoing communication between the wireless terminal itself and that wireless base station 101a, 101b, connects the wireless terminal to another one of the wireless terminals, gets a second piece of information (RSSI information) about a communication condition of ongoing communication between the two wireless terminals, and sends the first and second pieces of information to the server 102. The server 102 includes: a server communications circuit 1024 configured to get the first and second pieces of information from the terminal communications circuit 1044 of each wireless terminal 104a through 104d; and a processing circuit 1021 configured to locate the wireless terminals 104a through 104d in the predetermined space by reference to the first and second pieces of information and which outputs information about their locations.

As a result, when a wireless network is established between a plurality of wireless base stations 101a and 101b and a plurality of wireless terminals 104a through 104d, each of those wireless terminals can secure a certain communication band.

By reference to the first piece of information, the processing circuit 1021 of the server 102 associates each of the wireless terminals 104a through 104d with one of the wireless base stations 101a and 101b that has the best communication condition.

The processing circuit 1021 of the server 102 adjusts the number of wireless terminals that are associated with each wireless base station 101a, 101b on the basis of a certain value.

If the wireless base stations include a first wireless base station 101a, with which less than the certain number of wireless terminals are associated, and a second wireless base station 101b, with which more than the certain number of wireless terminals are associated, the processing circuit 1021 of the server 102 determines which of the wireless terminals 104c through 104f that are associated with the second wireless base station 101b is a first wireless terminal 104f that has the worst communication condition and also determines which of the wireless terminals is a second wireless terminal 104c that has the second worst communication condition, and associates one of the first and second wireless terminals 104f and 104c with the first wireless base station 101a by reference to the respective second pieces of information of the first and second wireless terminals 104f and 104c.

By reference to the respective second pieces of information of the first and second wireless terminals 104f and 104c, the processing circuit 1021 of the server 102 compares an average of the communications conditions of one or more wireless terminals that are associated with the first wireless base station 101a to an average of the communication conditions of multiple wireless terminals that are associated with the second wireless base station 101b with respect to each of the first and second wireless terminals 104f and 104c, and associates each of the first and second wireless terminals 104f and 104c with the wireless base station in the better communication condition.

According to the communication condition of ongoing communication defined by the first and second pieces of information about one or more wireless terminals 104a through 104f that are associated with each wireless base station 101a, 101b, the processing circuit 1021 of the server 102 locates the wireless terminals 104a through 104f in the predetermined space with respect to each wireless base station 101a, 101b.

The terminal communications circuit 1044 of each of the wireless terminals 104a through 104f is connected to its associated wireless base station 101a, 101b in an ad hoc mode.

The processing circuit 1021 of the server 102 determines, by the location of each wireless terminal 104a through 104f that has been determined, which of the wireless base stations 101a and 101b the wireless terminal 104a through 104f needs to be connected to.

One of the wireless base stations 101a and 101b and the server 102 may be arranged in the same housing.

One of the wireless terminals 104a through 104f and the server 102 may be arranged in the same housing.

If the location of each wireless base station 101a, 101b is determined in advance, the processing circuit 1021 of the server 102 may refer to information about the location of each wireless base station 101a, 101b.

### Embodiment 2

[2-1. Configuration]

FIG. 15 illustrates a configuration for a wireless network system 200 as a second embodiment of the present disclosure. In FIG. 15, any component also included in the system of the first embodiment and having substantially the same function as its counterpart is identified by the same reference numeral and description thereof will be omitted herein.

In this embodiment, the transmitting antenna of each wireless base station 101a, 101b is configured to change its directivity. In the example shown in FIG. 15, illustrated schematically is a situation where the directivity of the wireless base station 101b has been changed into a narrower one.

Hereinafter, it will be described how to change the directivity of the wireless base station 101b. Various methods can be adopted to change the directivity of a radio wave at a wireless base station. In this description, a technique for changing the directivity of a radio wave by providing multiple antennas with mutually different directivities for a wireless base station will be described.

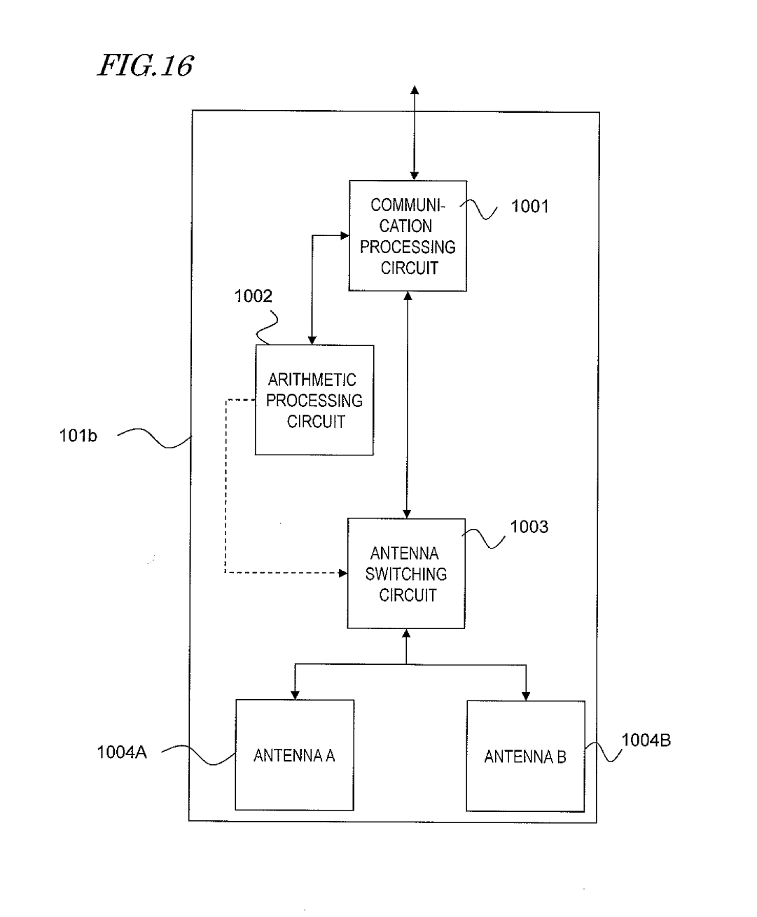

FIG. 16 illustrates the internal structure of the wireless base station 101b of this embodiment. The wireless base station 101b includes a communication processing circuit 1001, an arithmetic processing circuit 1002, an antenna switching circuit 1003 and antennas 1004A and 1004B. In the following description, the antenna 1004A will be referred to herein as “Antenna A”.

[2-2. Operation]

The communication processing circuit 1001 inputs and outputs communication data to/from this wireless base station 101b. The communication processing circuit 1001 corresponds to the communication processing circuit 1014 shown in FIG. 6.

If data is transmitted from the server 102 to the wireless terminals 104a through 104d, the processing is carried out in the following manner. Specifically, the communication processing circuit 1001 receives communication data from the server 102 and adds some kind of information such as an address if necessary. Also, the communication processing circuit 1001 converts the communication data into wireless data to be used in a wireless range by modulating the data, and then sends that data to the antenna switching circuit 1003, which is usually set to send data to only Antenna A. The wireless data is transmitted from Antenna A into the wireless range and will then be received at the wireless terminals 104a through 104d.

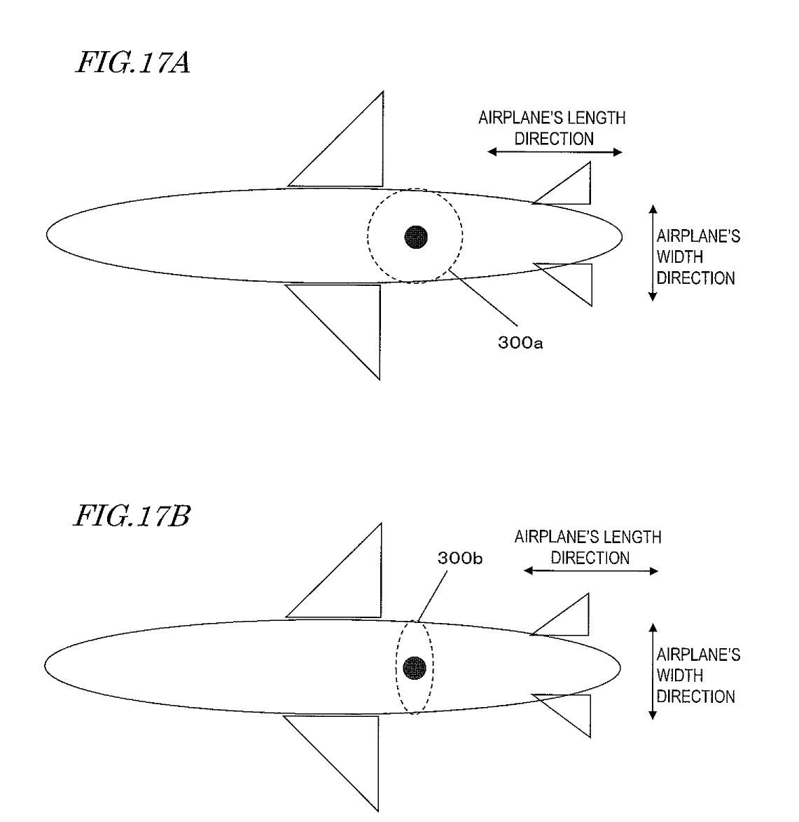

FIG. 17A illustrates a range 300a in which the wireless terminal 104 can obtain a reception sensitivity that is equal to or higher than a predetermined level when Antenna A is used. Antenna A is designed so as to radiate a radio wave uniformly both in the longitudinal direction and in the width direction of the airplane. That is to say, Antenna A has no directivity toward any particular direction.

FIG. 17B illustrates a range 300b in which the wireless terminal 104 can obtain a reception sensitivity that is equal to or higher than a predetermined level when Antenna B is used. Antenna B has strong directivity to the width direction of the airplane. Also, unlike Antenna A, Antenna B is designed so as not to radiate any radio wave in the longitudinal direction of the airplane (see FIG. 17A). As a result, when Antenna B is used, the range 300b becomes smaller than the range 300a when Antenna A is used particularly in the longitudinal direction of the airplane.

If the wireless terminals cannot be located by the method of the first embodiment because the RSSI values measured at the respective wireless terminals are not significantly different from each other, then the CPU 1021 of the server 102 changes the directivity of the wireless base station's antenna and then tries locating the wireless terminals all over again. In that case, processing is carried out in the following manner.

The CPU 1021 of the server 102 transmits antenna switching instruction data to the wireless base stations 101a and 101b over the wired network 103. The communication processing circuit 1001 of each of the wireless base stations 101a and 101b receives the antenna switching instruction data and passes it to the arithmetic processing circuit 1002.

After having received the antenna switching instruction data, the arithmetic processing circuit 1002 issues an antenna switching instruction to the antenna switching processing circuit 1003. In response, the antenna switching processing circuit 1003 disconnects Antenna A from the communication processing circuit 1001 and connects Antenna B to the communication processing circuit 1001 instead. On getting the switch to Antenna B done, the antenna switching processing circuit 1003 sends a notification of completion of switching to the arithmetic processing circuit 10002, which then forwards the notification of completion to the communication processing circuit 1001. In response, the communication processing circuit 1001 adds some kind of information such as address to the notification of completion and then sends it to the server 102 over the wired network 103. On receiving the notification of completion from every wireless base station, the CPU 1021 of the server 102 starts the processing of locating the wireless terminals as described for the first embodiment all over again.

In FIG. 15, even if the directivity of the wireless base station 101b changes, the wireless terminals 104c and 104d which are located in the vicinity of the wireless base station 101b are hardly affected. In the wireless terminals 104a and 104b which are located far away from the wireless base station 101b, on the other hand, the intensity of the radio wave received from the wireless base station 101b decreases significantly.

If the RSSI values are too close to each other to make a proper decision according to the method of the first embodiment described above, then the physical locations of wireless terminals which are located far away from some wireless base station can be determined by intentionally changing the directivity of the transmitting antenna of that base station.

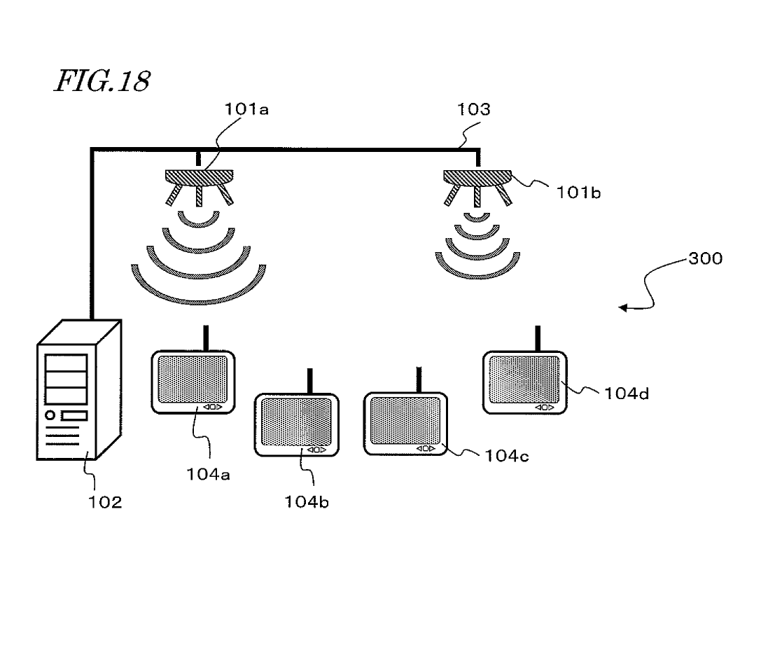

Alternatively, as in the wireless network system 300 shown in FIG. 18, the transmission power of some wireless base station may be increased or decreased. FIG. 18 illustrates a situation where the transmission power of the wireless base station 101b has been decreased, the degree of which may be determined by the maximum and minimum transmission powers. For example, if the transmission power is theoretically variable within the range of 1 dBm to 20 dBm but designed to be 15 dBm at maximum, then the transmission power may be decreased to approximately 7.5 dBm, which is a half as large as 15 dBm. Or the transmission power may even be decreased to approximately 3 dBm.

In FIG. 18, even if the transmission power of the wireless base station 101b is decreased, the wireless terminals 104c and 104d which are located in the vicinity of the wireless base station 101b are hardly affected. In the wireless terminals 104a and 104b which are located far away from the wireless base station 101b, on the other hand, the intensity of the radio wave received from the wireless base station 101b decreases significantly.

In the embodiment described above, a variation in RSSI is measured with a performance parameter on the transmitting end such as the directivity or transmission power of the antenna at a wireless base station changed. Alternatively, a variation in radio wave intensity may also be measured with an obstacle put in the space.

The method of this embodiment is supposed to be applied to a situation where respective RSSI values are too close to each other to make a proper decision according to the method of the first embodiment described above. However, the method of this second embodiment is not necessarily combined with that of the first embodiment. But the locations of the respective wireless terminals can also be estimated just by changing the directivity and transmission power of the transmitting antenna at the wireless base station 101a or 101b.

For example, in a situation where the intensities of the radio waves received at the wireless terminals 104b and 104c are substantially equal to each other when the transmission power of the wireless base station 101b is decreased, if the intensity of the radio wave received at the wireless terminal 104b is higher than that of the radio wave received at the other wireless terminal 104c by decreasing the transmission power of the wireless base station 101a, a decision can be made that the wireless terminal 104b be present at a location to be connected to the wireless base station 101a.

Even though the directivity or transmission power of the transmitting antenna at a wireless base station is supposed to be changed according to the embodiment described above, the directivity or the transmission power of the transmitting antenna at a wireless terminal may also be changed.

[2-3. Advantageous Effects, etc.]

The terminal communications circuit 1044 of each of the wireless terminals 104a through 104f gets the first and second pieces of information by using the radio wave intensity as an index to the communication condition of ongoing communication between the terminal itself and each wireless base station 101a, 101b and the communication condition of ongoing communication between the wireless terminals 104a through 104f.

The terminal communications circuit 1044 of each of the wireless terminals 104a through 104f gets the first and second pieces of information by using information about the frequency of occurrence of communication errors while data is being transmitted or received as an index to the communication condition of ongoing communication between the terminal itself and each wireless base station 101a, 101b and the communication condition of ongoing communication between the wireless terminals 104a through 104f.

Each wireless base station 101a, 101b includes a base station antenna 1013 to make communications with a first power and a communication processing circuit 1012 which sends and receives data via the base station antenna 1013. Each terminal communications circuit 1044 further includes terminal antenna 1047 to make communications with a second power. When the base station antenna 1013 of each wireless base station 101a, 101b changes the first power and/or when the terminal antenna 1047 of each terminal communications circuit 1044 changes the second power, the terminal communications circuit 1044 of each of the wireless terminals 104a through 104f gets the first and second pieces of information.

Each wireless base station 101a, 101b includes a base station antenna 1004A, 1004B, of which the directivity is switchable, and a communication processing circuit 1001 which sends and receives data via the base station antenna 1004A, 1004B. Each terminal communications circuit 1044 further includes a terminal antenna, of which the directivity is switchable. When the base station antenna of each wireless base station 101a, 101b changes its directivity and/or when the terminal antenna 1047 of each terminal communications circuit 1044 changes its directivity, the terminal communications circuit of each wireless terminal gets the first and second pieces of information.

In the first and second embodiments described above, only the radio wave intensities that have been measured in the ad hoc mode are supposed to be used for calculations. When connection is made in the ad hoc mode, the signal quality between a wireless base station and a wireless terminal and the signal quality between wireless terminals may be measured at the same time. In that case, since the signal qualities can be measured by connecting them only once, the job of determining the locations of wireless terminals can get done much more quickly. Furthermore, since the signal quality between wireless terminals and the signal quality between a wireless base station and a wireless terminal can be measured under the same radio wave propagation environment, highly accurate signal qualities can be obtained for comparison.

Optionally, not only the radio wave intensities that have been measured in the ad hoc mode but also radio wave intensities that have been measured in an infrastructure mode or any other results of measurement may be combined as well. Still alternatively, instead of combining the ad hoc mode and the infrastructure mode, the server 102 may collect the RSSI values from the respective wireless terminals 104 only in the infrastructure mode.

In the first and second embodiments described above, radio wave intensities are supposed to be used as an index to signal qualities. However, this is just an example of the present disclosure. Alternatively, the index may also be the frequency of occurrence of communication errors or the data arrival time delay while data is being transmitted or received from/at a wireless base station or between the wireless base station and a wireless terminal. The communication error may be a CRC error, for example. When communication errors are used, a wireless terminal at which errors will occur most frequently and a wireless terminal at which errors will occur second most frequently may be used as wireless terminals corresponding to the wireless terminals 104f and 104c of the first embodiment described above.

In the embodiments described above, the antennas are supposed to be switched at a time in every wireless base station 101a, 101b. However, this is only an example of the present disclosure. Optionally, the directivity of the antenna may be changed only at a particular wireless base station.

The directivity of an antenna may be changed by any of various methods. For example, a radio wave shielding aperture may be provided and a radio wave may be radiated through that aperture. By opening and closing the aperture, the directivity of an antenna can be switched.

In the foregoing description of embodiments, the locations of wireless base stations are not particularly paid attention to. In the case of an airplane, however, a wireless base station may be provided near the ceiling of its cabin or any other known location. In that case, location information about the location where the wireless base station is provided may be stored in advance in the server's ROM. The server's CPU may determine the relative location of a wireless terminal by reference to the wireless base station's location information. In that case, in determining the relative location of a wireless terminal, there is no need to treat the wireless base station's location information as a variable while making calculations. As a result, the calculations can get done much more quickly.

On top of that, by using the wireless base station's location information, it is possible to avoid looking at the arrangement of wireless base stations wrong end first by mistake. For example, suppose that in a situation where there are three base stations A, B and C, the results of calculations reveal that the three base stations are arranged in the order of A, B and C. Only with this order, however, it cannot be seen whether the wireless base station located at the front end of the airplane is wireless base station A or wireless base station C. That is to say, this means that it cannot be seen whether a wireless terminal to be connected to that wireless base station is located at the front end of the airplane or not. In an airplane, each group of seats called the first, business or economy classes is often arranged collectively in a predetermined area in an airplane. From the standpoint of providing quality service, it is highly necessary to locate a wireless terminal calling. That is why if the location of the base station is already known as described above, it is possible to avoid looking at the arrangement wrong end first.

In addition, the wireless base station's location information can also be used effectively even when IP addresses are allocated sequentially to those wireless terminals from the front end of an airplane toward its tail as described above.

According to an exemplary embodiment of the present disclosure, the wireless base stations and wireless terminals can be located more accurately than in the related art, and therefore, each wireless terminal can be connected to a wireless base station at an appropriate location. As a result, a communication band can be secured with good stability.

It should be noted that in a wireless network system, of which the locations and number of wireless terminals are unknown, it is difficult to determine the combinations of wireless base stations and wireless terminals in advance. According to the embodiments described above, however, even when the locations and number of wireless terminals are unknown, each of those wireless terminals can also be allocated to an appropriate wireless base station.

Furthermore, as an ordinary wireless LAN terminal often has the ad hoc mode as one of its standard modes of operations, the present disclosure can be carried out even without introducing special purposed hardware, or without increasing the overall cost.

When a service that needs to secure a certain communication band for each of multiple wireless terminals is provided for those wireless terminals as in video streaming, for example, the present disclosure can be used effectively to connect each of those wireless terminals to an appropriate wireless base station and establish a wireless network system. Thus, the present disclosure is broadly applicable to not just an airplane as in the foregoing description but also any other wireless network system that provides a similar service as well.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2011-278075 filed on Dec. 20, 2011 and No. 2012-228726 filed on Oct. 16, 2012, the entire contents of which are hereby incorporated by reference.

What is claimed is:

1. A wireless network system comprising wireless base stations, wireless terminals and a server, all of which are arranged in a predetermined space,
wherein each of the wireless terminals includes a terminal communications circuit which connects the wireless terminal to each of the wireless base stations, gets a first piece of information about a communication condition of ongoing communication between the wireless terminal itself and each of the wireless base stations, connects the wireless terminal to another one of the wireless terminals, gets a second piece of information about a communication condition of ongoing communication between the two wireless terminals, and sends the first and second pieces of information to the server, and
wherein the server includes:
a server communications circuit configured to get the first and second pieces of information from the terminal communications circuit of each said wireless terminal; and
a processing circuit configured to locate the wireless terminals in the predetermined space by reference to the first and second pieces of information and configured to output information about their locations.

2. The wireless network system of claim 1, wherein by reference to the first piece of information, the processing circuit of the server associates each of the wireless terminals with one of the wireless base stations that achieves the best communication condition.

3. The wireless network system of claim 2, wherein the processing circuit of the server adjusts the number of wireless terminals that are associated with each said wireless base station on the basis of a certain value.

4. The wireless network system of claim 3, wherein if the wireless base stations include a first wireless base station, with which less than the certain number of wireless terminals are associated, and a second wireless base station, with which more than the certain number of wireless terminals are associated,
the processing circuit of the server determines which of the wireless terminals that are associated with the second wireless base station is a first wireless terminal that has the worst communication condition and also determines which of the wireless terminals is a second wireless terminal that has the second worst communication condition, and associates one of the first and second wireless terminals with the first wireless base station by reference to the respective second pieces of information of the first and second wireless terminals.

5. The wireless network system of claim 4, wherein by reference to the respective second pieces of information of the first and second wireless terminals, the processing circuit of the server compares an average of the communications conditions of one or more wireless terminals that are associated with the first wireless base station to an average of the communication conditions of multiple wireless terminals that are associated with the second wireless base station with respect to each of the first and second wireless terminals, and associates each of the first and second wireless terminals with the wireless base station in the better communication condition.

6. The wireless network system of claim 2, wherein according to the communication condition of ongoing communication defined by the first and second pieces of information about one or more wireless terminals that are associated with each said wireless base station, the processing circuit of the server locates the wireless terminals in the predetermined space with respect to each said wireless base station.

7. The wireless network system of claim 1, wherein the terminal communications circuit of each said wireless terminal is connected to its associated wireless base station in an ad hoc mode.

8. The wireless network system of claim 1, wherein the processing circuit of the server determines, by the location of each said wireless terminal that has been determined, which of the wireless base stations the wireless terminal needs to be connected to.

9. The wireless network system of claim 1, wherein the terminal communications circuit of each said wireless terminal gets the first and second pieces of information by using the radio wave intensity as an index to the communication condition of ongoing communication between the terminal itself and each said wireless base station and the communication condition of ongoing communication between the wireless terminals.

10. The wireless network system of claim 1, wherein the terminal communications circuit of each said wireless terminal gets the first and second pieces of information by using information about the frequency of occurrence of communication errors while data is being transmitted or received as an index to the communication condition of ongoing communication between the terminal itself and each said wireless base station and the communication condition of ongoing communication between the wireless terminals.

11. The wireless network system of claim 1, wherein each said wireless base station includes a base station antenna to make communications with a first power and a communication processing circuit which sends and receives data via the base station antenna, and
wherein each said terminal communications circuit further includes a terminal antenna to make communications with a second power, and
wherein when the base station antenna of each said wireless base station changes the first power and/or when the terminal antenna of each said terminal communications circuit changes the second power, the terminal communications circuit of each said wireless terminal gets the first and second pieces of information.

12. The wireless network system of claim 1, wherein each said wireless base station includes a base station antenna, of which the directivity is switchable, and a communication processing circuit which sends and receives data via the base station antenna, and
wherein each said terminal communications circuit further includes a terminal antenna, of which the directivity is switchable, and
wherein when the base station antenna of each said wireless base station changes its directivity and/or when the terminal antenna of each said terminal communications circuit changes its directivity, the terminal communications circuit of each said wireless terminal gets the first and second pieces of information.

13. The wireless network system of claim 1, wherein one of the wireless base stations and the server are arranged in the same housing.

14. The wireless network system of claim 1, wherein one of the wireless terminals and the server are arranged in the same housing.

15. The wireless network system of claim 1, wherein if the location of each said wireless base station is determined in advance, the processing circuit of the server refers to information about the location of each said wireless base station.

16. A method to be carried out by a server of a wireless network system that includes wireless base stations, wireless terminals and the server, all of which are arranged in a predetermined space,
wherein each of the wireless terminals includes a terminal communications circuit which connects the wireless terminal to each of the wireless base stations, gets a first piece of information about a communication condition of ongoing communication between the wireless terminal itself and that wireless base station, connects the wireless terminal to another one of the wireless terminals, gets a second piece of information about a communication condition of ongoing communication between the two wireless terminals, and sends the first and second pieces of information to the server, and
wherein the method comprises the steps of:
getting the first and second pieces of information from the terminal communications circuit of each said wireless terminal;
locating the wireless terminals in the predetermined space by reference to the first and second pieces of information; and
outputting information about their locations.
